(19) United States
(12) Patent Application Publication
(10) Pub. No.: US 2015/0261545 A1
(43) Pub. Date: Sep. 17, 2015

(54) CORE SELECTION SCHEME

(71) Applicant: QUALCOMM Incorporated, San Diego, CA (US)

(72) Inventors: Sachin Dileep DASNURKAR, San Diego, CA (US); Krishna Reddy DUSETY, San Diego, CA (US); Prasad Rajeevalochanam BHADRI, San Diego, CA (US)

(21) Appl. No.: 14/327,377

(22) Filed: Jul. 9, 2014

Related U.S. Application Data
(60) Provisional application No. 61/952,081, filed on Mar. 12, 2014.

(51) Int. Cl. G06F 9/44

(52) U.S. Cl. CPC G06F 9/4403

(57) ABSTRACT

An apparatus includes a memory and at least one processor coupled to the memory is provided. The at least one processor is configured to read first information corresponding to an electrical characteristic of a first core on the at least one processor and second information corresponding to an electrical characteristic of a second core on the at least one processor and to select the first core or the second core for operation based on the first information and the second information. An integrated circuit on a substrate is provided. The integrated circuit includes a first core and a second core. A memory stores first information corresponding to an electrical characteristic of the first core and second information corresponding to an electrical characteristic of the second core. A default core includes the first core or the second core configured to read the first information and the second information.

### CROSS-REFERENCE TO RELATED APPLICATION(S)

This application claims the benefit of U.S. Provisional Application Ser. No. 61/952,081, titled “PROCESSOR CORE SELECTION ALGORITHM FOR SELECTING OPTIMUM CORES FOR SOFTWARE EXECUTION USING PRE-STORED INFORMATION BASED ON AUTOMATED TEST EQUIPMENT TEST AND CHARACTERIZATION” and filed on Mar. 12, 2014, which is expressly incorporated by reference herein in its entirety.

### BACKGROUND

1. Field

The disclosure relates to electronic apparatuses and, in particular, to electronic apparatuses with integrated circuits (ICs) containing multiple cores.

2. Background

Wireless communication technologies and devices (e.g., cellular phones, tablets, laptops, etc.) have grown in popularity and use over the past several years. Increasingly, mobile electronic devices have grown in complexity and now commonly include multiple processors (e.g., the baseband processor and the application processor) and other resources that allow mobile device users to execute complex and power intensive software applications (e.g., music players, web browsers, video streaming applications, etc.). To meet the increasing performance demand, the processors are designed to include multiple cores. That is, each integrated circuit (IC) substrate of the processor may include multiple cores. An example of such core includes a central processing unit (CPU), and each core may include its own CPU and cache.

### SUMMARY

Aspects of a method for operating an electronic apparatus are disclosed. The method includes reading, from an integrated circuit, first information corresponding to an electrical characteristic of a first core on the integrated circuit and second information corresponding to an electrical characteristic of a second core on the integrated circuit and selecting the first core or the second core for operation based on the first information and the second information.

Aspects of an apparatus including a memory and at least one processor coupled to the memory are disclosed. The at least one processor is configured to read first information corresponding to an electrical characteristic of a first core on the at least one processor and second information corresponding to an electrical characteristic of a second core on the at least one processor and to select the first core or the second core for operation based on the first information and the second information.

Aspects of an integrated circuit on a substrate are provided. The integrated circuit includes a first core and a second core. A memory stores first information corresponding to an electrical characteristic of the first core and second information corresponding to an electrical characteristic of the second core. A default core includes the first core or the second core configured to read the first information and the second information.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 illustrates a wireless communication device and communication systems in which an exemplary embodiment may be included.

FIG. 2 is a block diagram of a wireless communication device in which an exemplary embodiment may be included.

FIG. 3 is a flow chart of an exemplary embodiment for selecting a core for operation.

FIG. 4 is a conceptual data flow diagram illustrating the data flow between different modules/means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of IC design will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

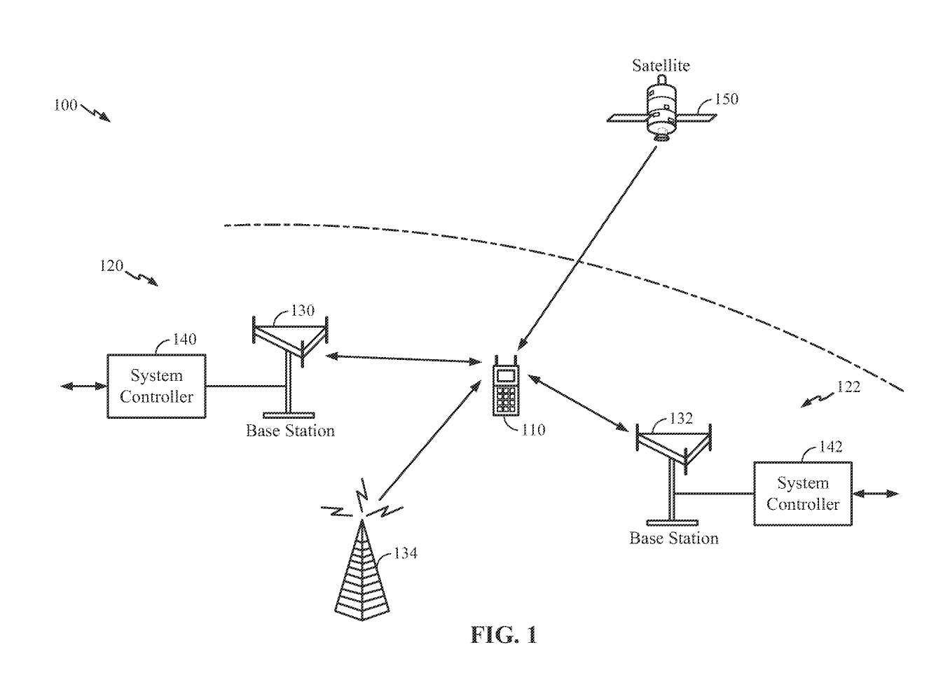

FIG. 1 illustrates a wireless communication device (e.g., wireless device 110) and communication systems (e.g., wireless systems 120 and 122) in which an exemplary embodiment may be included. The wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1X or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, the wireless system 120 may be a GSM system, and the wireless system 122 may be a WCDMA system. As another example, the wireless system 120 may be an LTE system, and the wireless system 122 may be a CDMA system.

For simplicity, the diagram 100 shows the wireless system 120 including one base station 130 and one system controller 140, and the wireless system 122 including one base station 132 and one system controller 142. In general, each wireless system may include any number of base stations and any set of network entities. Each base station may support communication for wireless devices within the coverage of the base station. The base stations may also be referred to as a Node B, an evolved Node B (eNB), an access point, a base transceiver station, a radio base station, a radio transceiver, a transceiver function, a basic service set (BSS), an extended service set (ESS), or some other suitable terminology. The wireless device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. The wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

The wireless device 110 may be capable of communicating with the wireless system 120 and/or 122. The wireless device 110 may also be capable of receiving signals from broadcast stations, such as the broadcast station 134. The wireless device 110 may also be capable of receiving signals from satellites, such as the satellite 150, in one or more global navigation satellite systems (GNSS). The wireless device 110 may support one or more radio technologies for wireless communication such as GSM, WCDMA, cdma2000, LTE, 802.11, etc. The terms “radio technology,” “radio access technology,” “air interface,” and “standard” may be used interchangeably.

The wireless device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink share the same frequency, and downlink transmissions and uplink transmissions may be sent on the same frequency in different time periods. For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE.

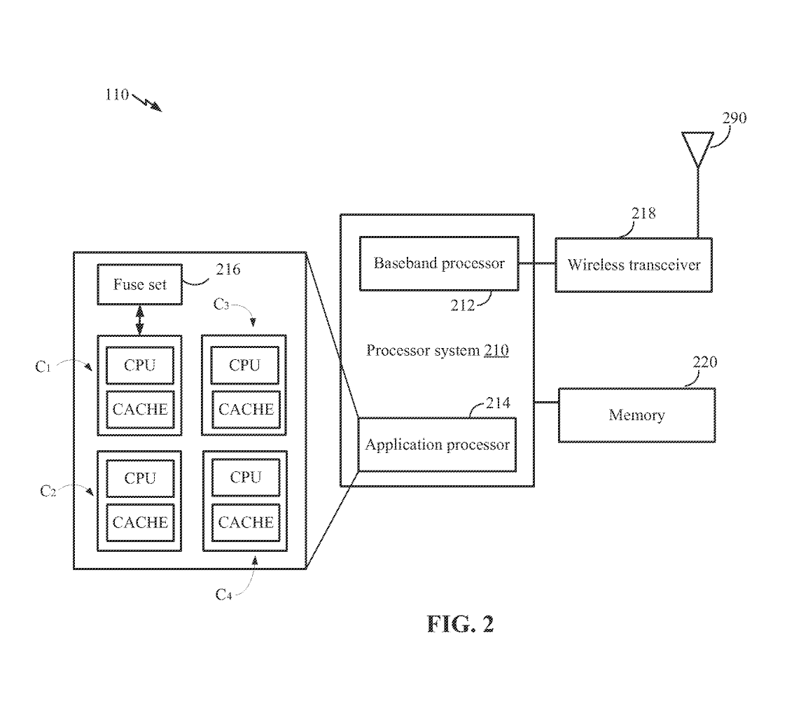

FIG. 2 illustrates a block diagram of a wireless communication device (such as the wireless device 110) in which an exemplary embodiment may be included. The wireless transceiver 218 communicates with an antenna 290 for supporting the various wireless bi-directional communications described above. For example, the wireless transceiver 218 performs the radio frequency (RF) functions of the wireless device 110. The wireless transceiver 218 may receive a digital signal for transmission from the baseband processor 212, and convert the digital signal to an analog RF signal. The analog RF signal is provided to the antenna 290 for transmission. The wireless transceiver 218 may further receive an RF signal from the antenna 290 and convert it to a digital signal. The wireless transceiver 218 may provide the digital signal to the baseband processor 212 for processing.

The wireless device 110 includes the processor system 210, which includes the baseband processor 212 and the application processor 214. The baseband processor 212 communicates with the wireless transceiver 218. In one example, the baseband processor 212 receives data (e.g., from the application processor 214) for transmission and modulates the data. The modulated data is provided to the wireless transceiver 218 as the digital signal for transmission. The baseband processor 212 may further receive a digital signal from the wireless transceiver 218. The baseband processor 212 may demodulate the received digital signal and obtain the data carried by the digital signal. The application processor 214 operates and processes the various functions of the wireless device 110 (e.g., music player, web browsers, video streaming applications, etc.). In that regard, the application processor 214 may include a graphic unit for displaying an image, a global positioning unit for locating the wireless device 110, an audio unit for telephony and music applications, and/or a connectivity unit for WiFi, near field communication, and Bluetooth functions. The processor system 210 communicates with the memory 220. Examples of the memory 220 include static random access memory (SRAM), dynamic random access memory (SRAM), flash memory, read only memory (ROM), registers, a hard disk, a removable disk, a CD-ROM, and so forth.

As an example, the application processor 214 includes four cores C₁-C₄. In one example, each of the four cores C₁-C₄ is a collection of circuits. In another example, each of the four cores C₁-C₄ includes an execution unit that manipulates (e.g., adds, subtracts, moves, or stores) data as instructed by, e.g., software. As shown, each of the four cores C₁-C₄ includes a CPU (which includes an execution unit) and its own cache. The cache may be an instruction cache, a data cache, or both. The application processor 214 further includes a fuse set 216, which is an example of a non-volatile memory. The fuse set 216 is configured to store various information associated with each of the cores C₁-C₄, as described below. While the application processor 214 in a wireless device 110 is cited as an example here, a person of ordinary skill in the art would readily recognize that the scope of this disclosure is limited neither to an application processor nor to a wireless device.

Embodiments described herein provide for methods and apparatus to optimize core usage of processors to, e.g., maximize performance and minimize power consumption. For example, embodiments provide for characterizing the processor cores for electrical characteristics (e.g., multiple power and performance metrics). The electrical characteristics for each core of the processor (e.g., application processor 214) are then stored on the processor. An apparatus (e.g., wireless device 110) incorporating the processor may then read back the stored information to select the cores for operation based on the work load and the specific application. In this fashion, the selection of the cores may be tailored for each processor and/or for each application.

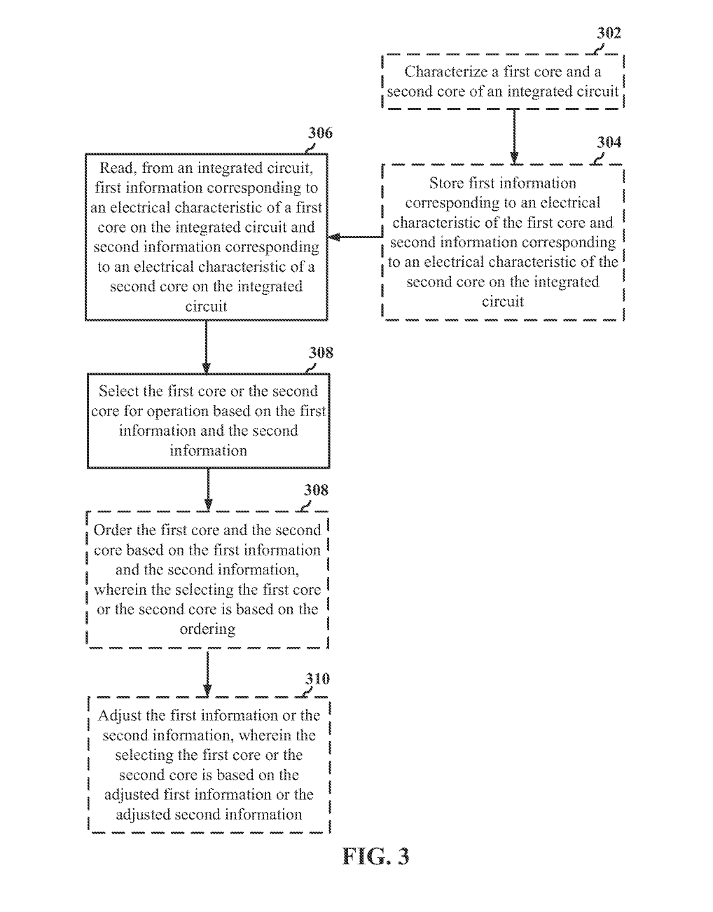

FIG. 3 is a flow chart of an exemplary embodiment for selecting a core for operation. The steps boxed in dotted line may be optional. An integrated circuit on a substrate including multiple cores, such as the application processor 214, may be fabricated and provided for testing. Typically, an automatic testing equipment (ATE) is used for the testing and characterization. At 302, the electrical characteristics of the first core C₁ and the second core C₂ are characterized. The electrical characteristics may include performance metrics such as speed metrics (e.g., how fast does the core operate) and power metrics (e.g., how much power does the core consume when operating). The electrical characteristics may differ from device to device. At 304, first information corresponding to an electrical characteristic (e.g., speed metrics or power metrics) of the first core and second information corresponding to an electrical characteristic (e.g., speed metrics or power metrics) of the second core are stored on the integrated circuit (e.g., the application processor 214). For example, the first information and the second information are stored in the fuse set 216. The ATE may blow certain fuses in the fuse set 216 (the first information and the second information) to indicate the electrical characteristics associated with each of the first core and the second core.

At 306, the first information corresponding to an electrical characteristic of the first core stored on the integrated circuit and the second information corresponding to an electrical characteristic of the second core stored on the integrated circuit are read from the integrated circuit (e.g., the application processor 214). In one example, the packaged application processor 214 containing cores C₁-C₄ is incorporated into the wireless device 110. The wireless device 110, based on software installed thereon, may instruct the application processor 214 to read the fuse set 216 to obtain the stored first information corresponding to an electrical characteristic of the first core and second information corresponding to an electrical characteristic of the second core (see 304). In one example, a default core of the application processor 214 performs the reading from the fuse set 216. A default core may be a core that performs certain functions prior to the wireless device 110 selecting a core. For example, a default core C1 reads from the fuse set 216 before the wireless device 110 selects a core for operation.

At 308, the first core or the second core is selected for operation based on the first information and the second information. For example, the wireless device 110 selects a core among the cores C₁-C₄ for operation based on the first information and the second information and in accordance with the software stored thereon. While a device has multiple cores, not all cores offer the same performance. In one aspect, the wireless device 110 selects the most suitable core for a particular application. One core may be better suited for a particular use than another. The core selection may be targeted toward the particular needs of specific applications. For example, if performance is not an issue for a particular application, a slower core may be selected. Moreover, the selection process may be dynamic (e.g., the selection algorithm and/or a ranking of the cores may change dynamically) and adaptive.

At 308, the first core and the second core are ordered based on the first information and the second information. The selection of the first core or the second core is based on the order. In an example, the order may be based on power consumption. For an application for which power reduction is an important factor, the wireless device 110 may select the cores for operation based on an order of increasing power consumption. For example, the stored information may indicate that the core C₁ consumes the most power, followed by C₂, then C₃, and finally C₄, which consumes the least power. The wireless device 110 may order the cores C₄, C₃, C₂, and C₁, and select cores for operation according to the order for applications which are concerned with power consumption.

At 310, the first information or the second information is adjusted. The selection of the first core or the second core is based on the adjusted first information or the adjusted second information. For example, implementation software may provide adjustment factors or thermal coefficients Kₜ₀, Kₜ₁, . . . , Kₜₓ for each core. Power coefficients Kₚ₀, Kₚ₁, Kₚ₂, . . . , Kₚₓ (examples of electrical characteristics) for each core are stored and read. The net power and thermal weights are then determined by multiplying the power and thermal matrices:

[W₀,W₁, . . . ,W_{X}]=[Kₜ₀,Kₜ₁, . . . ,Kₜₓ]×[Kₚ₀,Kₚ₁,Kₚ₂, . . . ,Kₚₓ].

The cores selected may be those with the lowest W weights.

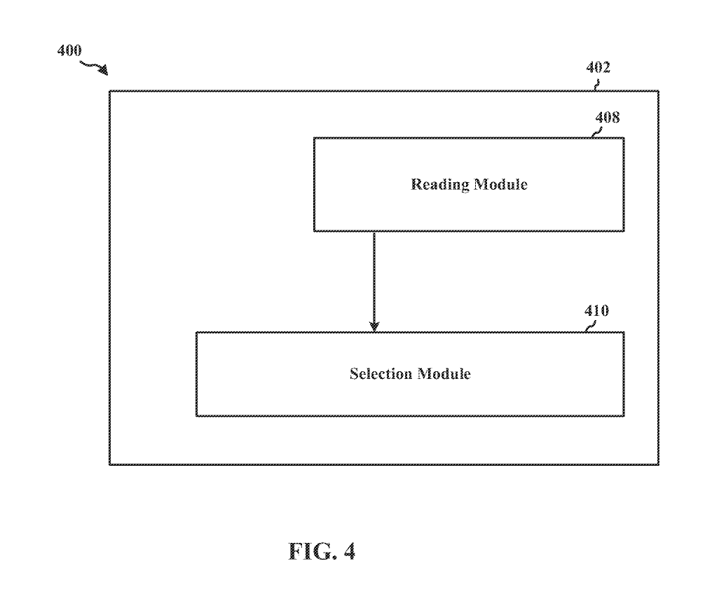

FIG. 4 is a conceptual data flow diagram 400 illustrating the data flow between different modules/means/components in an exemplary apparatus 402. The apparatus 402 may be a computer or a processor coupled to a memory for initiating the modules in hardware or software. For example, for a firmware and/or software implementation, the methodologies may be implemented with the modules (e.g., procedures, functions, and the like) that perform the steps described in FIG. 3. Any machine-readable medium tangibly embodying instructions may be used in implementing this routine. The apparatus 402 includes a reading module 408 that reads, from an integrated circuit, first information corresponding to an electrical characteristic of a first core on the integrated circuit and second information corresponding to an electrical characteristic of a second core on the integrated circuit and a selection module 410 that selects the first core or the second core for operation based on the first information and the second information.

The apparatus may include additional modules that perform (or provide the means for) each of the steps of the algorithm in the aforementioned flow chart of FIG. 3. As such, each step in the aforementioned flow charts of FIG. 3 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

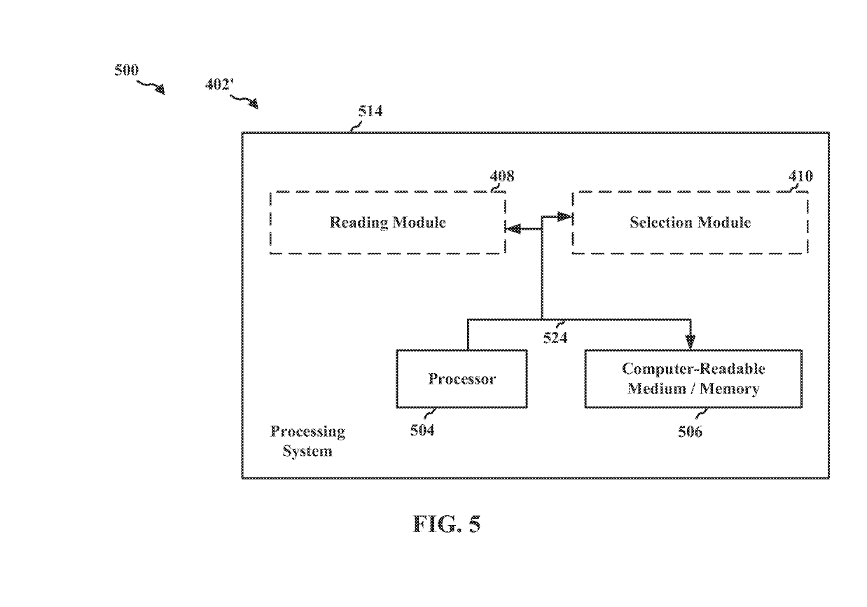

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by the processor 504, the modules 408, 410 and the computer-readable medium/memory 506. The bus 524 may also link various other circuits such as timing sources, peripherals, voltage regulators, and power management circuits, which are well known in the art, and therefore, will not be described any further.

The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system further includes at least one of the modules 408 and 410. The modules may be software modules running in the processor 504, resident/stored in the computer readable medium/memory 506, one or more hardware modules coupled to the processor 504, or some combination thereof.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for operating an electronic apparatus, comprising:
reading, from an integrated circuit, first information corresponding to an electrical characteristic of a first core on the integrated circuit and second information corresponding to an electrical characteristic of a second core on the integrated circuit; and
selecting the first core or the second core for operation based on the first information and the second information.

2. The method of claim 1, further comprising ordering the first core and the second core based on the first information and the second information, wherein the selecting the first core or the second core is based on the ordering.

3. The method of claim 1, further comprising adjusting the first information or the second information, wherein the selecting the first core or the second core is based on the adjusted first information or the adjusted second information.

4. The method of claim 3, wherein the adjusting the first information or the second information comprises applying an adjusting factor to the first information or the second information.

5. The method of claim 1, wherein the electrical characteristic of the first core or the electrical characteristic of the second core comprises a speed performance or a power performance.

6. The method of claim 1, wherein the reading from the integrated circuit comprises reading from a non-volatile memory storing the first information and the second information.

7. The method of claim 1, wherein one of the first core and the second core is configured as a default core, and the reading from the integrated circuit or the selecting the first core or the second core is performed by the default core.

8. The method of claim 1, wherein each of the first core and the second core includes at least one execution unit.

9. An apparatus, comprising:
a memory; and
at least one processor coupled to the memory and configured to:
read first information corresponding to an electrical characteristic of a first core on the at least one processor and second information corresponding to an electrical characteristic of a second core on the at least one processor; and
select the first core or the second core for operation based on the first information and the second information.

10. The apparatus of claim 9, wherein the at least one processor is further configured to order the first core and the second core based on the first information and the second information, and to select the first core or the second core based on the order.

11. The apparatus of claim 9, wherein the at least one processor is further configured to adjust the first information or the second information, and to select the first core or the second core based on the adjusted first information or the adjusted second information.

12. The apparatus of claim 11, wherein the at least one processor is configured to adjust the first information or the second information by applying an adjusting factor to the first information or the second information.

13. The apparatus of claim 9, wherein the electrical characteristic of the first core or the electrical characteristic of the second core comprises a speed performance or a power performance.

14. The apparatus of claim 9, wherein the at least one processor is configured to read the first information and the second information by reading the memory, which comprises a non-volatile memory.

15. The apparatus of claim 9, wherein one of the first core and the second core is configured as a default core, and the at least one processor is configured to read the first information and the second information or to select the first core or the second core using the default core.

16. The apparatus of claim 9, wherein each of the first core and the second core includes at least one execution unit.

17. An integrated circuit on a substrate, comprising:
a first core and a second core;
a memory storing first information corresponding to an electrical characteristic of the first core and second information corresponding to an electrical characteristic of the second core; and
a default core comprising the first core or the second core configured to read the first information and the second information.

18. The integrated circuit of claim 17, wherein the default core is further configured to select the first core or the second core for operation based on the first information and the second information.

19. The integrated circuit of claim 18, wherein the memory is a non-volatile memory.

20. The integrated circuit of claim 19, wherein the memory comprises a fuse set.
